(19) United States
(12) Patent Application Publication
(10) Pub. No.: US 2018/0011901 A1
(43) Pub. Date: Jan. 11, 2018

(54) Method and Query Optimization Server for Associating Functions with Columns for Optimizing Query Execution

(71) Applicant: Huawei Technologie Co., Ltd., Shenzhen (CN)

(72) Inventors: Dilip Kumar, Karnataka (IN); Kumar Rajeev Rastogi, Bangalore (IN); Nirmala Sreekantaiah, Bangalore (IN)

(21) Appl. No.: 15/676,049

(22) Filed: Aug. 14, 2017

Related U.S. Application Data
(63) Continuation of application No. PCT/CN2016/073135, filed on Feb. 2, 2016.

(30) Foreign Application Priority Data
Feb. 12, 2015 (IN) IN682/CHE/2015

(51) Int. Cl. G06F 17/30

(52) U.S. Cl. CPC G06F 17/30442; G06F 17/30339; G06F 17/30864

(57) ABSTRACT

A method of optimizing query execution by associating functions with columns includes receiving, by a query optimization server, data definition statement including information of one or more columns and function information for each of the one or more columns. The query optimization server associates the columns having the function information with corresponding predefined functions and stores in a memory. Upon receiving a query comprising a function associated to a column, the query optimization server compares the function with predefined functions stored in the memory. The query optimization server accesses the predefined function from the memory for executing the query based on the comparison.

### CROSS-REFERENCE TO RELATED APPLICATIONS

This application is a continuation of International Patent Application No. PCT/CN2016/073135 filed on Feb. 2, 2016, which claims priority to Indian Patent Application No. IN682/CHE/2015 filed on Feb. 12, 2015. The disclosures of the aforementioned applications are hereby incorporated by reference in their entireties.

### TECHNICAL FIELD

The present disclosure relates generally to database management systems and, in particular, to a system and method for optimizing query execution by associating functions with columns.

### BACKGROUND

Generally, data in a database is accessed using queries. A query is a statement in a particular syntax that specifies the data to be retrieved from the database. A query processor typically processes the query, identifies the best plan for executing the query and retrieves data from the database that matches the parameters specified in the query. One example of the database query and programming language is Structured Query Language (SQL), which is used to store, retrieve and query the data stored in the relational database system.

Presently, queries associated with the mathematical functions like average (AVG), sum, max, min, etc. are executed by invoking a function manager at run time. The function manager provides a respective mathematical function like AVG function, sum function, maximum function, and minimum function during the run time execution of the query as per the column data type defined in the query. Consider the below query examples.

CREATE TABLE test (a int, b int, c varchar) (1)

SELECT AVG (a) FROM test WHERE b>100 (2)

Upon execution of the “CREATE” query, a table is created in the database with three columns namely column a, column b and column c. For executing the “SELECT” query, the function manager determines during the runtime that the column type “a” is an integer, and therefore an integer AVG function has to be invoked for executing the query. This creates an extra overhead on the execution process to invoke the respective mathematical function using the function manager, which in turn affects performance of the query execution.

To overcome the above mentioned problem, the functions are predefined and stored such that they can be accessed directly during the runtime. But, there are numerous mathematical functions and also numbers of columns for a table would be enormous. Therefore, it is difficult to precompile and predefine all the possible combinations of the functions.

### SUMMARY

The objective of the present disclosure is to optimize the query execution by predefining functions and by accessing the functions, which are associated with the columns provided in the query, directly at run time execution.

The present disclosure relates to a method of associating functions with columns for optimizing query execution. The method comprises receiving a definition statement comprising information of one or more columns for creating a table by a query optimization server. Upon receiving the definition statement, the query optimization server determines the presence of one or more function information for each of the one or more columns in the definition statement. If the one or more function information is provided in the definition statement, the query optimization server associates each of the one or more columns having the one or more function information with corresponding predefined functions for optimizing the query execution.

In an embodiment, the present disclosure provides a method for receiving a query statement by the query optimization server. The query statement comprises one or more functions associated with one or more columns, for querying a database. Upon receiving the query statement, the query optimization server compares the one or more functions associated with the one or more columns with predefined functions associated to the one or more columns in the memory. The query optimization server accesses the predefined function associated to the one or more columns from the memory based on the comparison for executing the query statement.

The present disclosure provides a query optimization server for optimizing query execution by associating functions with columns. The query optimization server comprises a receiving module, determination module and association module. The receiving module receives a definition statement comprising information of one or more columns for creating a table from one or more client devices. The receiving module also receives a query statement for querying the database. The determination module determines the presence of one or more function information for each of the one or more columns in the definition statement after receiving the definition statement. The association module associates each of the one or more columns having the one or more function information with corresponding predefined functions for optimizing the query execution.

In an embodiment, the query optimization server comprises a comparison module and accessing module. The comparison module compares the one or more functions associated with the one or more columns with predefined functions associated to the one or more columns in the memory. The accessing module accesses the predefined function associated with the one or more columns from the memory based on the comparison, for execution of the one or more query statements.

The present disclosure relates to a non-transitory computer readable medium including operations stored thereon that when processed by at least one processor cause a query optimization server to perform the steps of receiving a definition statement comprising information of one or more columns for creating a table. The method further comprises determining presence of one or more function information for each of the one or more columns in the definition statement. Upon determining the presence of the function information, the query optimization associates each of the one or more columns having the one or more function information with corresponding predefined functions, for optimizing the query execution.

In an embodiment, the instructions further cause the at least one processing unit to perform one or more actions by performing the acts of receiving a query statement comprising one or more functions associated with one or more columns, for querying a database. Then the act of comparing the one or more functions associated with the one or more columns with predefined functions associated to the one or more columns in the memory is performed. Finally the predefined function with the one or more columns is accessed from the memory based on the comparison for execution of the query statement.

The present disclosure relates to a computer program for performing one or more actions on a query processing system. The said computer program comprising code segment for code segment for receiving a definition statement comprising information of one or more columns for creating a table, code segment for determining presence of one or more function information for each of the one or more columns in the definition statement and code segment for associating each of the one or more columns having the one or more function information with corresponding predefined functions, for optimizing the query execution.

In an embodiment, the present disclosure provides a method for associating functions with columns defined in the data definition statement. The user can provide one or more function information for each column in the data definition statement. Based on the one or more function information, the corresponding predefined functions are associated with the columns and stored in the memory. When a query statement is received which comprises the function associated with columns, the corresponding function is directly accessed from the memory. Therefore, there is no requirement for invoking the function manager for executing the query statement. This improves the query execution performance. Further, the one or more predefined functions are stored in the memory based on the function information in the data definition statement. This reduces the computing resources as there is no need to predefine all the functions in the memory.

The foregoing summary is illustrative only and is not intended to be in any way limiting. In addition to the illustrative aspects and features described above, further aspects, and features will become apparent by reference to the drawings and the following detailed description.

### BRIEF DESCRIPTION OF THE DRAWINGS

The novel features and characteristic of the present disclosure are set forth in the appended claims. The embodiments of the present disclosure itself, however, as well as a preferred mode of use, further objectives and advantages thereof, will best be understood by reference to the following detailed description of an illustrative embodiment when read in conjunction with the accompanying drawings. One or more embodiments are now described, by way of example only, with reference to the accompanying drawings.

FIG. 1 shows exemplary network architecture for optimizing query execution by associating functions with columns in accordance with some embodiments of the present disclosure;

FIG. 2A shows a block diagram illustrating a query optimization server with processor and memory for optimizing query execution in accordance with some embodiments of the present disclosure;

FIG. 2B shows a detailed block diagram illustrating a query optimization server for optimizing query execution by associating functions with columns in accordance with some embodiments of the present disclosure;

FIG. 3A and FIG. 3B shows an exemplary block diagram illustrating a method for optimizing query execution by associating functions with columns in accordance with some embodiments of the present disclosure;

FIG. 4A illustrates a flowchart showing method for associating functions with columns in accordance with some embodiments of the present disclosure;

FIG. 4B illustrates a flowchart showing method for accessing functions directly during run-time in accordance with some embodiments of the present disclosure;

FIG. 5 illustrates a block diagram of an exemplary computer system for implementing embodiments consistent with the present disclosure;

FIG. 6A illustrates the association of the columns with the corresponding predefined functions; and

FIG. 6B illustrates the query optimization server identifying the predefined function.

The figures depict embodiments of the present disclosure for purposes of illustration only. One skilled in the art will readily recognize from the following description that alternative embodiments of the structures and methods illustrated herein may be employed without departing from the principles of the present disclosure described herein.

### DETAILED DESCRIPTION

The foregoing has broadly outlined the features and technical advantages of the present disclosure in order that the detailed description of the present disclosure that follows may be better understood. Additional features and advantages of the present disclosure will be described hereinafter which form the subject of the claims of the disclosure. It should be appreciated by those skilled in the art that the conception and specific aspect disclosed may be readily utilized as a basis for modifying or designing other structures for carrying out the same purposes of the present disclosure. It should also be realized by those skilled in the art that such equivalent constructions do not depart from the scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

Embodiments of the present disclosure relate to a method and a query optimization server for optimizing query execution by associating functions with columns. A user provides a definition statement comprising information of one or more columns for creating a table in a database. A query optimization server receives the definition statement, executes the definition statement and creates the table in the database using the information of the one or more columns. The query optimization server further determines the presence of one or more function information for each of the one or more columns in the definition statement. The one or more function information is defined by the user in the definition statement. As an example, the function information comprises mathematical functions like AVG, maximum (max), minimum (min), sum etc. If the function information is present in the definition statement, then the query optimization server associates the one or more columns having the function information with corresponding predefined functions. The information about each of the one or more columns and the corresponding predefined functions are stored in a memory. Consequently, the query optimization server receives a query statement comprising one or more functions associated with one or more columns, for querying a database. Upon receiving the query statement, the query optimization server compares the one or more functions associated with the one or more columns with predefined functions associated to the one or more columns. If the one or more functions associated with the one or more columns matches with the predefined functions, the query optimization server accesses the predefined functions from the memory for executing the query statement.

Henceforth, embodiments of the present disclosure are explained with the help of exemplary diagrams and one or more examples. However, such exemplary diagrams and examples are provided for the illustration purpose for better understanding of the present disclosure and should not be construed as limitation on scope of the present disclosure.

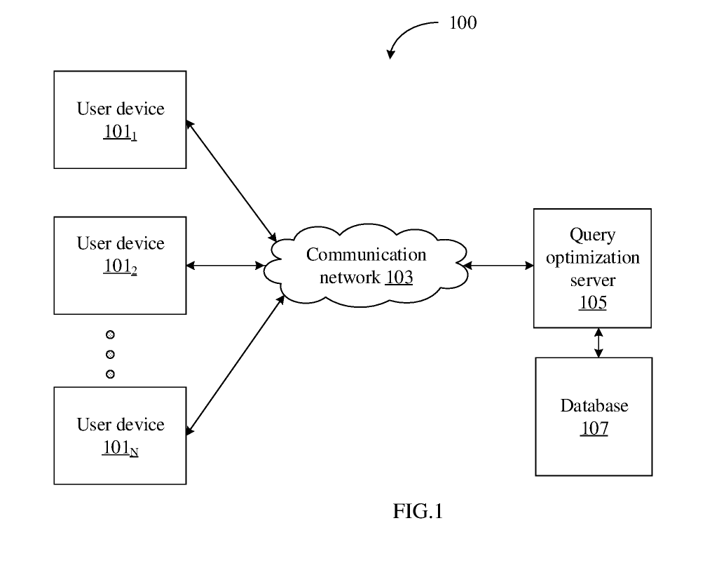

FIG. 1 shows exemplary network architecture for optimizing query execution by associating functions with columns in accordance with some embodiments of the present disclosure.

As shown in FIG. 1, the network architecture 100 comprises a query optimization server 105 for optimizing query execution by associating functions with columns. The architecture 100 also comprises one or more user devices 101₁, 101₂, . . . 101_{N} (collectively referred to as user devices 101) and a database 107 connected to the query optimization server 105. As shown in the FIG. 1, such user devices 101 are communicatively coupled to a query optimization server 105 through a communication network 103 for facilitating accessing the database 107 for information.

The user devices 101 comprise an application program that uses the services of the query optimization server 105. The user devices 101 with the application program may be implemented in a variety of computing systems, such as a laptop computer, a desktop computer, a notebook, a workstation, a mainframe computer, a server, a network server, and the like. The user devices 101 may be used by various stakeholders or end users of the organization, such as project managers, executives and employees. In an embodiment, the user devices 101 are used by associated users to create one or more queries. The user devices 101 are installed with one or more interfaces (not shown in FIG. 1) for communicating with the query optimization server 105 over the network 103. In an embodiment, the query optimization server 105 can act as user device 101. Therefore, the one or more queries are directly received at the query optimization server 105 for query execution and user interaction.

The database 107 stores information of one or more establishments in a predefined format or structures or extensions, such as but are not limiting to, a flat file, a hierarchical on-line analytical processing (OLAP) data cube, a multidimensional cubes, a relational data store, an OLAP data cube and an EXCEL file. A person skilled in the art should understand that there can be any number of databases that stores information.

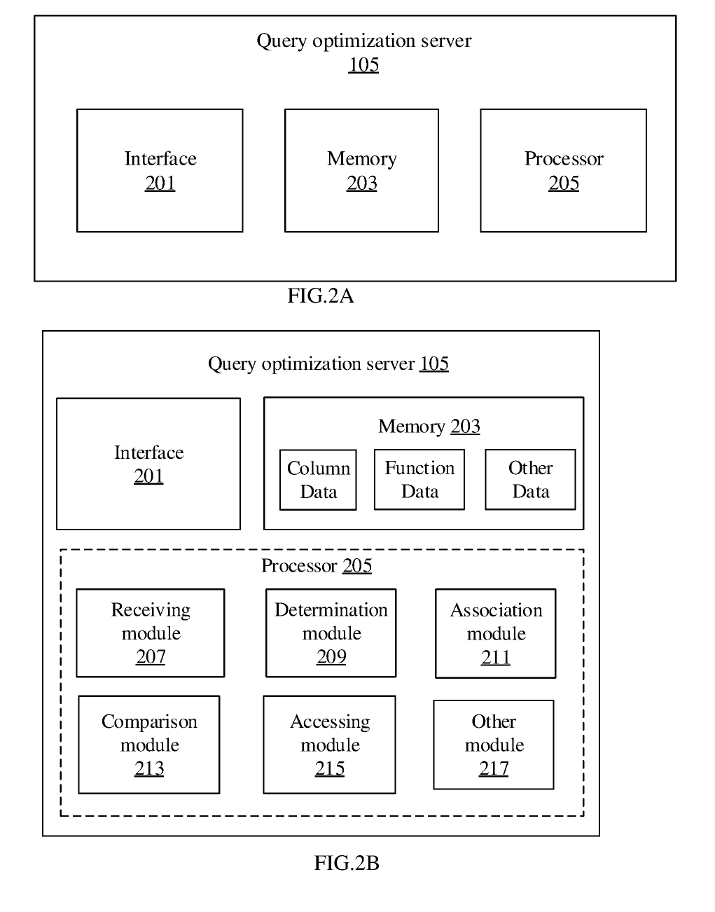

FIG. 2A shows an exemplary block diagram illustrating a query optimization server 105 with a processor 205 and memory 203 for optimizing query execution by associating functions with columns in accordance with some embodiments of the present disclosure.

The query optimization server 105 comprises an Interface 201, the memory 203 and the processor 205. The interface 201 is coupled with the processor 205 through which data are received from the one or more user devices 101. The memory 203 is communicatively coupled to the processor 205. The memory 203 stores processor-executable instructions which on execution cause the processor 205 to perform one or more steps. In an embodiment, the processor 205 receives one or more definition statements from the one or more user devices 101. The one or more definition statements include information about one or more columns for creating one or more tables in the database 107. The tables organize the information into rows and columns. The definition statements also include one or more function information for each column. The function information comprises mathematical functions associated with the columns. The processor 205 associates the columns with corresponding predefined functions based on the function information. The predefined functions are the precompiled mathematical functions based on the function information. The predefined functions are stored in the memory 203. The processor 205 may also receive one or more query statements from the one or more user devices 101. The one or more query statements may include one or more functions associated with one or more columns. The processor 205 compares the one or more functions associated with the one or more columns with the predefined functions associated to one or more columns. If the one or more functions matches with the predefined functions, the processor 205 accesses the predefined function for executing the query statement.

FIG. 2B shows a detailed block diagram illustrating a query optimization server 105 for optimizing query execution by associating functions with columns in accordance with some embodiments of the present disclosure.

In an embodiment, the query optimization server 105 receives data from one or more user devices. In one example, the data may be stored within the memory 203. In one implementation, the data may include column data, function data, and other data.

In an embodiment, the column data may include information of one or more columns for creating a Table in a database.

In an embodiment, the function data may include information of one or more functions for each of the one or more columns. As an example, the function may include, but not limited to, a mathematical function like AVG, sum, minimum, aggregate and maximum. A person skilled in the art should understand that any other functions which involve invoking the function manager can be used in the present disclosure.

The memory 203 may also include other data which may comprise temporary data and temporary files, generated by the modules for performing the various functions of the query optimization server.

In one embodiment, the data may be stored in the memory 203 in the form of various data structures. Additionally, the aforementioned data may be organized using data models, such as relational or hierarchical data models. In an embodiment, the data are processed by modules of the query optimization server 105.

In an embodiment, the data received from the one or more user devices are processed by modules of the query optimization server 105. The modules may be stored within the processor 205. As used herein, the term module refers to an application specific integrated circuit (ASIC), an electronic circuit, a processor (shared, dedicated, or group) and memory 203 that execute one or more software or firmware programs, a combinational logic circuit, and/or other suitable components that provide the described functionality.

The modules may include, for example, a receiving module 207, a determination module 209, an association module 211, a comparison module 213, accessing module 215 and other module 217. In an embodiment, the modules may perform the described functions independently or as a part of the processor 205.

In an embodiment, the receiving module 207 is configured to receive the data definition statement and the data query statement from the one or more user devices. The data definition statements include information about one or more columns for creating a table in the database. The data definition statement also includes one or more function information associated with the one or more columns. In an embodiment, the information about one or more functions is provided as “HINT” in the data definition statement. As an example, a data definition statement is as given below in equation (3). The below data definition statement is for creating a table namely “test”. The number of columns defined in the below data definition statement are three namely “col a”, “col b”, and “col c”. The mathematical functions AVG and sum are associated with “col a” and the mathematical function (max) is associated with the “col b”.

CREATE TABLE test (a int, b int, c varchar) /* HINT: a (sum), a (avg), b (max) */ (3)

The data query statement may comprise one or more functions associated with one or more columns. An example data query statement is as given below in equation (4). The below data query statement comprises the function (avg) associated with the “col a”.

SELECT AVG (a) FROM test WHERE b>100 (4).

The determination module 209 is configured to identify the presence of the function information in the data definition statement in equation (1). As an example, the determination module 209 identifies the presence of the function information “sum”, “avg” and “max” for the “col a” and “col b” in the exemplary data definition statement given above.

The association module 211 is configured to associate the columns defined in the data definition statement with corresponding predefined functions based on the function information. The associated functions with the columns are stored in a memory 203.

The comparison module is 213 configured to compare the functions in the data query statement with predefined functions associated to the one or more columns stored in the memory 203

The accessing module 215 is configured to access the predefined functions associated with the one or more columns from the memory 203 for querying the database.

The query optimization server 105 may also comprise other modules 217 to perform various miscellaneous functionalities of the query optimization server 105. It will be appreciated that such aforementioned modules may be represented as a single module or a combination of different modules.

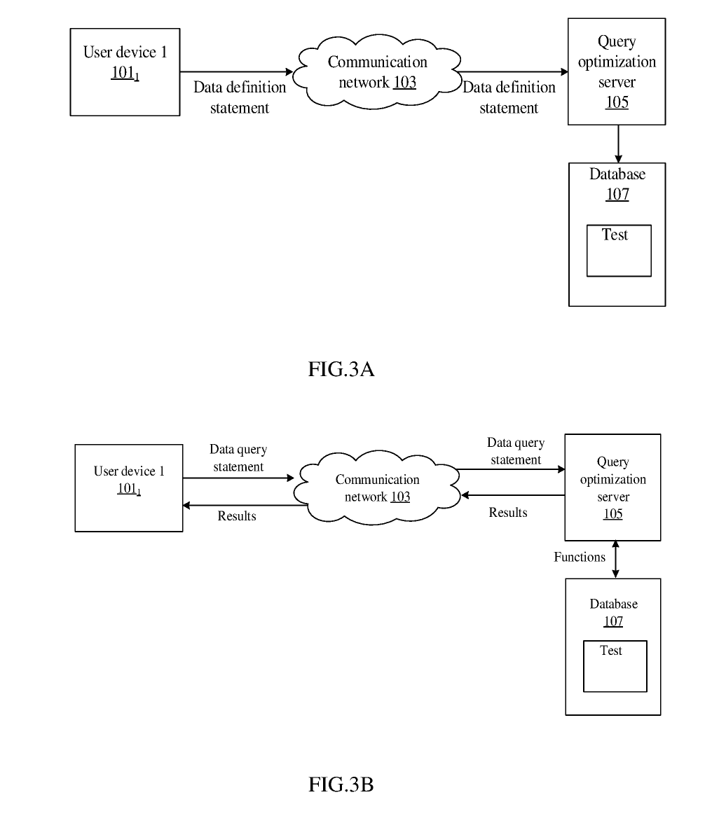

FIGS. 3A-3B shows an exemplary block diagram illustrating a method for optimizing query execution by association functions with columns in accordance with some embodiments of the present disclosure.

As shown in FIG. 3A, the user of the user device 101₁ defines a data definition statement as given below in equation (5) using SQL.

CREATE TABLE test (a int, b int, c varchar) /* HINT: a (sum), a (avg), b (max) */ (5).

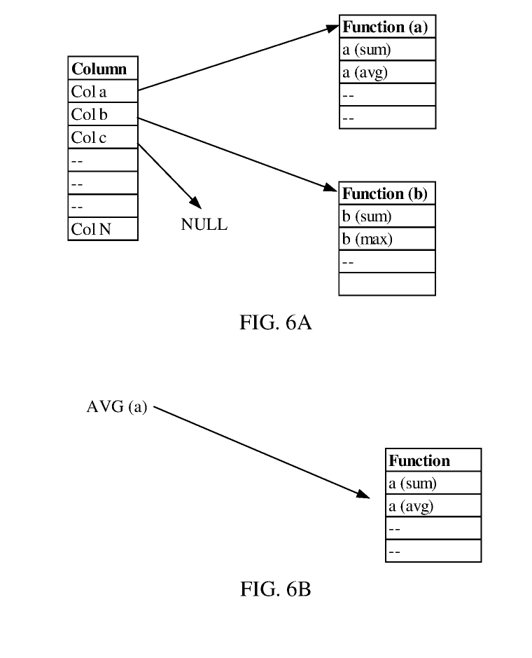

The user device 101₁ transmits the data definition language to the query optimization server 105 through the communication network 103. The receiving module in the query optimization server 105 receives the data definition statement. Upon receiving the data definition statement, the query optimization server 105 creates a table namely “test” in the database 107. The table “test” comprises of three columns namely “col a”, “col b”, and “col c”. The “col a” and “col b” is of the integer type and the “col c” is of the variable character type. The determination module identifies the presence of the function information i.e., “HINT” in the data definition statement. The function information is provided for “col a” and “col b”. Upon determining the presence of the function information, the association module associates each of the columns having the function information with corresponding predefined functions based on the function information. For example, the functions “sum” and “avg” are associated with “col a” the function “max” is associated with “col b”. As an example, referring to FIG. 6A, a table namely “column” is stored in the memory which comprises information of one or more columns provided in the data definition statement. The, “col a”, “col b” and “col c” is stored in the table “column”. Similarly, one or more tables are stored in the memory which comprises predefined functions associated with the columns. As an example, the table namely “function a” comprises one or more functions associated with “col a” and the table namely “function b” comprises one or more functions associated with “col b”. The “col a” contains a pointer which includes address at which the corresponding predefined function is stored. Similarly, the “col b” contains a pointer which includes address at which the corresponding predefined function is stored. The “col c” does not contain the function information and therefore there is no association of the function for the “col c”. Therefore, “col c” points to NULL. The association of the columns with the corresponding predefined functions is shown in FIG. 6A.

The “col a” contains a pointer for the function sum and avg. Similarly, the “col b” contains a pointer for the function max.

As shown in FIG. 3B, the user provides a data query statement for retrieving data from the database 107. The receiving module of the query optimization server 105 receives the data query statement from the user device 101₁ through the communication network 103. Upon receiving the data query statement, the data optimization server 105 analyzes the data query statement for executing the data query statement. As an example, the data query statement received form the user device 101₁ is as given below in equation (6).

SELECT AVG (a) FROM test WHERE b>100. (6).

The data query statement is to retrieve the AVG of “col a” from the table “test” in the database 107 where the value of “col b” is greater than 100. The function (avg) is associated with “col a”. The comparison module compares the function (avg) associated with the “col a” with predefined functions stored in the memory for “col a”. The query optimization server 105 identifies that the function (avg) associated with “col a” matches with the predefined function stored in the memory as shown below FIG. 6B.

The accessing module accesses the function (avg) from the memory for executing the data query statement.

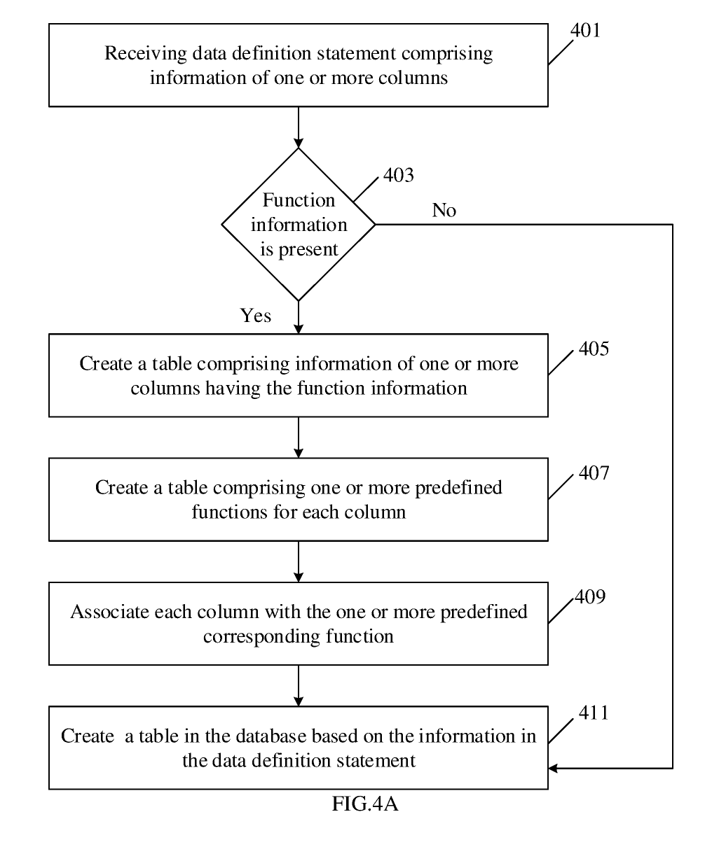

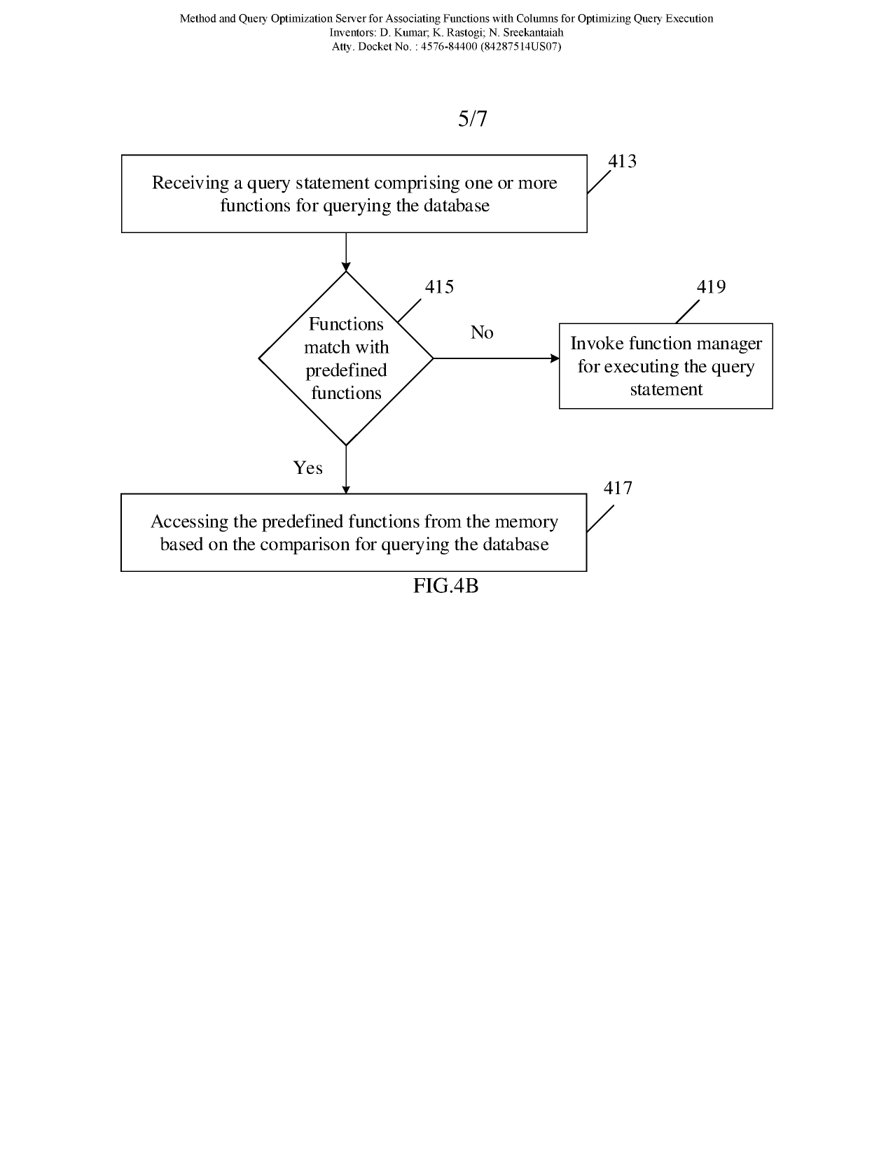

FIG. 4A illustrates a flowchart showing method for associating functions with columns in accordance with some embodiments of the present disclosure.

As illustrated in FIGS. 4A and 4B the methods comprises one or more blocks for optimizing query execution by associating functions with columns. The methods may be described in the general context of computer executable instructions. Generally, computer executable instructions can include routines, programs, objects, components, data structures, procedures, modules, and functions, which perform particular functions or implement particular abstract data types.

The order in which the methods are described is not intended to be construed as a limitation, and any number of the described method blocks can be combined in any order to implement the methods. Additionally, individual blocks may be deleted from the methods 400, without departing from the spirit and scope of the subject matter described herein. Furthermore, the methods can be implemented in any suitable hardware, software, firmware, or combination thereof.

At step 401, a receiving module receives a data definition statement. In an embodiment, the receiving module of the query optimization server receives a data definition statement from a user device. The data definition statement comprises information of one or more columns for creating a table in a database.

At step 403, a determination module determines if the function information is present in the data definition statement. As an example, the function information may be provided for each column in the data definition statement. If the data definition statement includes the function information, then the method proceeds to step 405 via “Yes”. If the function information is not present in the data definition statement then the method proceeds to step 411 via “No”.

At step 405, a table is created in the database comprising information of one or more columns having the function information. The query optimization server creates a table in the memory. The memory comprises information of one or more columns having the function information. For example, if “col a” and “col b” has the function information, then “col a” and “col b” are stored in the table.

At step 407, a table is created in the database comprising one or more predefined functions for one or more columns. The predefined functions are configured by the user in the memory 203. The query optimization server 105 creates a table in the memory 203 which comprises one or more predefined functions for one or more columns. The predefined functions are configured based on the function information.

At step 409, an association module associates each column with the one or more predefined corresponding function. The association module associates the columns having the function information with the predefined functions based on the function information.

At step 411, the table defined in the data definition statement is created in the database. The query optimization server creates a table in the database based on the column information defined in the data definition statement.

FIG. 4B illustrates a flowchart showing method of accessing functions directly during run-time in accordance with some embodiments of the present disclosure.

At step 413, the receiving module receives a data query statement. A user provides the data query statement for retrieving data from the database. In an embodiment, the data query statement may comprise information of one or more functions associated with the columns.

At step 415, the comparison module compares the one or more functions with predefined functions. The one or more functions associated with each column in the data query statement are compared with the predefined functions. If the one or more functions associated with each column match with the corresponding predefined functions then the method proceeds to step 417 via “Yes”. If the one or more functions associated with each column do not match with the corresponding predefined functions then the method proceeds to step 419 via “No”.

At step 417, the accessing module accesses the predefined function from the memory. The query optimization server determines the match between the function in the data query statement with the one or more predefined functions stored in the memory. The accessing module accesses the predefined function from the memory for executing the data query statement during run time.

At step 419, the query optimization server invokes the function manager which in turn calls respective mathematical function for executing the data query statement.

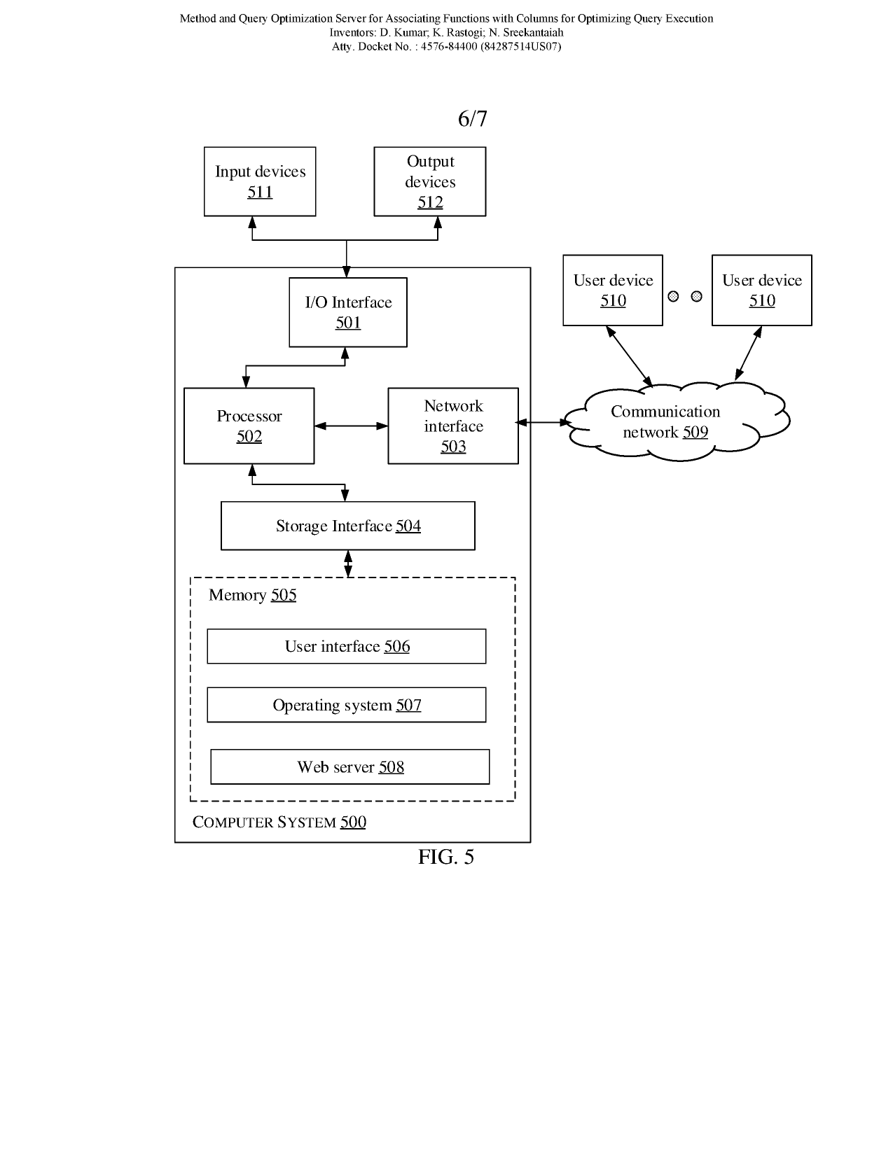

FIG. 5 illustrates a block diagram of an exemplary computer system 500 for implementing embodiments consistent with the present disclosure. In an embodiment, the computer system 500 is used to implement the query optimization server shown in foregoing embodiments. The computer system 500 optimizes query execution by associating functions with columns. The computer system 500 may comprise a processor 502. The processor 502 may be a central processing unit (CPU). The processor 502 may comprise at least one data processor for executing program components for executing user- or system-generated business processes. A user may include a person, a person using a device such as such as those included in this disclosure, or such a device itself. The processor 502 may include specialized processing units such as integrated system (bus) controllers, memory management control units, floating point units, graphics processing units, digital signal processing units, etc.

The processor 502 may be disposed in communication with one or more input/output (I/O) devices (511 and 512) via I/O interface 501. The I/O interface 501 may employ communication protocols/methods such as, without limitation, audio, analog, digital, monaural, Rolling circle amplification (RCA), stereo, The Institute of Electrical and Electronics Engineers (IEEE)-1394, serial bus, universal serial bus (USB), infrared, PS/2, Bayonet Neill-Concelman (BNC), coaxial, component, composite, digital visual interface (DVI), high-definition multimedia interface (HDMI), radio frequency (RF) antennas, S-Video, Video Graphics Array (VGA), IEEE 802.n /b/g/n/x, BLUETOOTH, cellular (e.g., code-division multiple access (CDMA), high-speed packet access (HSPA+), global system for mobile communications (GSM), long-term evolution (LTE), WIMAX, or the like), etc.

Using the I/O interface 501, the computer system 500 may communicate with one or more I/O devices (511 and 512). For example, the input device 511 may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device 512 may be a printer, fax machine, video display (e.g., Cathode Ray Tube (CRT), Liquid Crystal Display (LCD), Light-Emitting Diode (LED), plasma, Plasma Display Panel (PDP), Organic Light-Emitting Diode Display (OLED) or the like), audio speaker, etc.

In some embodiments, the processor 502 may be disposed in communication with a communication network 509 via a network interface 503. The network interface 503 may communicate with the communication network 509. The network interface 503 may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc. The communication network 509 may include, without limitation, a direct interconnection, Local Area Network (LAN), Wide Area Network (WAN), wireless network (e.g., using Wireless Application Protocol), the Internet, etc. Using the network interface 503 and the communication network 509, the computer system 500 may communicate with a user device 510.

In some embodiments, the processor 502 may be disposed in communication with a memory 505 (e.g., random access memory (RAM), read-only memory (ROM), etc. not shown in FIG. 5) via a storage interface 504. The storage interface 504 may connect to memory 505 including, without limitation, memory drives, removable disc drives, etc., employing connection protocols such as Serial Advanced Technology Attachment (SATA), Integrated Drive Electronics (IDE), IEEE-1394, USB, fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 505 may store a collection of program or database components, including, without limitation, user interface 506, an operating system 507, web server 508 etc. In some embodiments, computer system 500 may store user/application data, such as the data, variables, records, etc. as described in this disclosure. Such databases may be implemented as fault-tolerant, relational, scalable, secure databases such as Oracle or Sybase.

The operating system 507 may facilitate resource management and operation of the computer system 500. Examples of operating systems include, without limitation, APPLE Incorporation MACINTOSH, UNIX, UNIX-like system distributions (e.g., Berkeley Software Distribution (BSD), FREEBSD, NETBSD, OPENBSD, etc.), LINUX distributions (e.g., RED HAT, UBUNTU, KUBUNTU, etc.), IBM OS/2, MICROSOFT WINDOWS (XP, Vista/7/8, etc.), APPLE IOS, GOOLE ANDROID, BLACKBERRY OS, or the like. User interface 506 may facilitate display, execution, interaction, manipulation, or operation of program components through textual or graphical facilities. For example, user interfaces may provide computer interaction interface elements on a display system operatively connected to the computer system 500, such as cursors, icons, check boxes, menus, scrollers, windows, widgets, etc. Graphical User Interfaces (GUIs) may be employed, including, without limitation, APPLE MACHINTOSH operating systems AQUA, IBM OS/2, MICROSOFT WINDOWS (e.g., Aero, Metro, etc.), UNIX X-WINDOWS, web interface libraries (e.g., ActiveX, JAVA, JAVASCRIPT, AJAX, HTML, ADOBE FLASH, etc.), or the like.

In some embodiments, the computer system 500 may implement a web server 508 stored program component. The web browser may be a hypertext viewing application, such as MICROSOFT INTERNET EXPLORER, GOOGLE CHROME, MOZILLA FIREFOX, APPLE SAFARI, etc. Secure web browsing may be provided using Secure Hypertext Transport Protocol (HTTPS), Secure Sockets Layer (SSL), Transport Layer Security (TLS), etc. Web browsers may utilize facilities such as AJAX, DHTML, ADOBE FLASH, JAVASCRIPT, JAVA, Application Programming Interfaces (APIs), etc. In some embodiments, the computer system 500 may implement a mail server stored program component. The mail server may be an Internet mail server such as MICROSOFT EXCHANGE, or the like. The mail server may utilize facilities such as ASP, ActiveX, American National Standards Institute (ANSI) C++/C#, Microsoft .NET, CGI scripts, Java, JAVASCRIPT, PERL, PHP, PYTHON, WebObjects, etc. The mail server may utilize communication protocols such as Internet Message Access Protocol (IMAP), Messaging Application Programming Interface (MAPI), MICROSOFT EXCHANGE, Post Office Protocol (POP), Simple Mail Transfer Protocol (SMTP), or the like. In some embodiments, the computer system 500 may implement a mail client stored program component. The mail client may be a mail viewing application, such as APPLE MAIL, MICROSOFT ENTOURAGE, MICROSOFT OUTLOOK, MICROSOFT THUNDERBIRD, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include RAM, ROM, volatile memory, nonvolatile memory, hard drives, compact disc (CD) ROMs, digital versatile discs (DVDs), flash drives, disks, and any other known physical storage media. Additionally, advantages of present disclosure are illustrated herein.

Embodiments of the present disclosure help the user to define the one or more function information for each column in the data definition statement.

Embodiments of the present disclosure reduce the overhead of the function manager to call the respective functions at run time execution of the query.

Embodiments of the present disclosure provide predefined functions for various columns of the table. Therefore, the functions can be accessed directly during run time using column identification. The present disclosure avoids generation of huge set of precompiled functions. The present disclosure optimizes query execution by saving time. The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor and a processor capable of processing and executing the queries. A non-transitory computer readable medium may comprise media such as magnetic storage medium (e.g., hard disk drives, floppy disks, tape, etc.), optical storage (CD-ROMs, DVDs, optical disks, etc.), volatile and non-volatile memory devices (e.g., electrically erasable programmable ROMs (EEPROMs), ROMs, programmable ROMs (PROMs), RAMs, dynamic RAMs (DRAMs), Static RAMs (SRAMs), Flash Memory, firmware, programmable logic, etc.), etc. Further, non-transitory computer-readable media comprise all computer-readable media except for a transitory. The code implementing the described operations may further be implemented in hardware logic (e.g., an integrated circuit chip, Programmable Gate Array (PGA), Application Specific Integrated Circuit (ASIC), etc.).

Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a non-transitory computer readable medium at the receiving and transmitting stations or devices. An “article of manufacture” comprises non-transitory computer readable medium, hardware logic, and/or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the disclosure, and that the article of manufacture may comprise suitable information bearing medium known in the art.

The terms “an embodiment”, “embodiment”, “embodiments”, “the embodiment”, “the embodiments”, “one or more embodiments”, “some embodiments”, and “one embodiment” mean “one or more (but not all) embodiments of the disclosure(s)” unless expressly specified otherwise. The terms “including”, “comprising”, “having” and variations thereof mean “including but not limited to”, unless expressly specified otherwise. The enumerated listing of items does not imply that any or all of the items are mutually exclusive, unless expressly specified otherwise. The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the disclosure.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the disclosure need not include the device itself.

The illustrated operations of FIGS. 4A and 4B show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based here on. Accordingly, the embodiments of the present disclosure are intended to be illustrative, but not limiting, of the scope of the disclosure, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

We claim:

1. A method of associating functions with columns for optimizing query execution, comprising:
receiving, by a query optimization server, a definition statement comprising information of one or more columns for creating a table;
determining, by the query optimization server, presence of one or more function information for each of the one or more columns in the definition statement; and
associating, by the query optimization server, each of the one or more columns having the one or more function information with corresponding predefined functions for optimizing the query execution.

2. The method according to claim 1, wherein the one or more columns and the corresponding predefined functions are stored in a memory.

3. The method according to claim 2, further comprising:
receiving, by the query optimization server, a query statement comprising one or more functions associated with one or more columns for querying a database;
comparing, by the query optimization server, the one or more functions associated with the one or more columns with predefined functions associated to the one or more columns in the memory; and
accessing, by the query optimization server, the predefined functions associated to the one or more columns from the memory based on the comparison for execution of the query statement.

4. The method according to claim 1, wherein the one or more function information are provided by a user in the definition statement.

5. A non-transitory computer readable medium including operations stored thereon that when processed by at least one processor cause a query optimization server to perform a method comprising:
receiving a definition statement comprising information of one or more columns for creating a table;
determining presence of one or more function information for each of the one or more columns in the definition statement; and
associating each of the one or more columns having the one or more function information with corresponding predefined functions for optimizing the query execution.

6. The non-transitory computer readable medium according to claim 5, wherein the one or more columns and the corresponding predefined functions are stored in a memory.

7. The non-transitory computer readable medium according to claim 6, further comprising:
receiving a query statement comprising one or more functions associated with one or more columns for querying a database;
comparing the one or more functions associated with the one or more columns with predefined functions associated to the one or more columns in the memory; and
accessing the predefined functions associated to the one or more columns from the memory based on the comparison for execution of the query statement.

8. The non-transitory computer readable medium according to claim 5, wherein the one or more function information are provided by a user in the definition statement.

9. A query optimization server, comprising:
a memory configured to store computer readable instructions; and
a processor coupled to the memory, wherein the computer readable instructions cause the processor to be configured to:
receive a definition statement comprising information of one or more columns for creating a table;
determine presence of one or more function information for each of the one or more columns in the definition statement; and
associate each of the one or more columns having the one or more function information with corresponding predefined functions for optimizing the query execution.

10. The query optimization server according to claim 9, wherein the one or more columns and the corresponding predefined functions are stored in the memory.

11. The query optimization server according to claim 10, wherein the computer readable instructions further cause the processor to be configured to:
receive a query statement comprising one or more functions associated with one or more columns for querying a database;
compare the one or more functions associated with the one or more columns with predefined functions associated to the one or more columns in the memory; and
access the predefined functions associated to the one or more columns from the memory based on the comparison for execution of the query statement.

12. The query optimization server according to claim 9, wherein the one or more function information are provided by a user in the definition statement.
